(19) United States
(12) Patent Application Publication
(10) Pub. No.: US 2026/0235865 A1
(43) Pub. Date: Aug. 13, 2026

(54) VIBRATING DEVICE AND INTERNAL VIBRATING BODY

(71) Applicant: Murata Manufacturing Co., Ltd., Nagaokakyo-shi (JP)

(72) Inventors: Noritaka KISHI, Nagaokakyo-shi (JP); Yuka TANAKA, Nagaokakyo-shi (JP); Yuuki ISHII, Nagaokakyo-shi (JP); Akihiro HIRAKA, Nagaokakyo-shi (JP)

(21) Appl. No.: 19/639,597

(22) Filed: Apr. 6, 2026

Related U.S. Application Data
(63) Continuation of application No. PCT/JP2024/020343, filed on Jun. 4, 2024.

(30) Foreign Application Priority Data
Oct. 26, 2023 (JP) 2023-184092

(51) Int. Cl. G02B 27/00; B06B 1/06; G02B 7/02; H04N 23/55

(52) U.S. Cl. CPC G02B 27/0006; B06B 1/0655; G02B 7/02; H04N 23/55

(57) ABSTRACT

A vibrating device is provide that includes an internal vibrating body for amplifying vibration; a piezoelectric element connected to one end of the internal vibrating body in a first direction and that generates the vibration; a light transmission body that is connected to another end of the internal vibrating body in the first direction and that includes an optical axis extending along the first direction; and an external vibrating body that is positioned on an outer side of the internal vibrating body in a second direction intersecting the first direction and that surrounds the internal vibrating body. The external vibrating body includes a first connection portion connected to the light transmission body, a second connection portion extending in a direction away from the light transmission body along the second direction from the first connection portion, and a cylinder portion extending along the first direction.

### CROSS REFERENCE TO RELATED APPLICATIONS

This application is a continuation of International Application No. PCT/JP2024/020343, filed June 04, 2024, which claims priority to Japanese Patent Application No. 2023-184092, filed October 26, 2023, the entire contents of each of which are hereby incorporated by reference in their entirety.

### TECHNICAL FIELD

The present disclosure relates to a vibrating device and an internal vibrating body.

### BACKGROUND

Japanese Unexamined Patent Application Publication No. 2019-109381 discloses a lens unit including a cylindrical lens barrel and a lens group. In this disclosure, the lens barrel forms an inner accommodation space for accommodating and holding lenses, and the lens group is incorporated in the inner accommodation space of the lens barrel and includes a plurality of lenses arranged along an optical axis so as to be placed upon each other. In the lens unit described therein, an elastic member is interposed between the lenses and/or between the lenses and the lens barrel or a side member to absorb deformation in an optical axis direction of the lenses.

When a device that removes raindrops by vibrating such a lens unit is used, there may be a case in which the vibration is attenuated by the elastic member and foreign substances adhered to the lenses cannot be removed.

### SUMMARY OF THE INVENTION

In view of the foregoing, the present disclosure provides a vibrating device and an internal vibrating body that are configured to remove foreign substances adhered to a light transmission body while suppressing deformation of the light transmission body.

In an exemplary aspect, a vibrating device is provided that includes an internal vibrating body configured to amplify vibration; a piezoelectric element that is connected to a first end of the internal vibrating body in a first direction and that is configured to generate vibration; a light transmission body that is connected to a second end of the internal vibrating body in the first direction and that includes an optical axis extending along the first direction; and an external vibrating body that is positioned on an outer side of the internal vibrating body in a second direction intersecting the first direction and that surrounds the internal vibrating body. In the exemplary aspect, the external vibrating body includes a first connection portion that is connected to the light transmission body, a second connection portion that extends in a direction away from the light transmission body along the second direction from the first connection portion and attenuate vibration, and a cylinder portion that extends along the first direction and that includes a first end and a second end. In this aspect, the first end is connected to the first connection portion, and the second end is connected to the second connection portion. Moreover, a suppressing portion is provided that suppresses a difference between a deformation amount of the first end portion and a deformation amount of the second end portion, the difference being caused by the vibration generated by the piezoelectric element. In an exemplary aspect, the suppressing portion is positioned between the light transmission body and the second connection portion in the first direction.

In another exemplary aspect, an internal vibrating body is provided in which a first end is connected in a first direction to a piezoelectric element that generates vibration, and a second end that is connected in the first direction to a light transmission body including an optical axis extending along the first direction, and that is surrounded by an external vibrating body that is positioned on an outer side in a second direction intersecting the first direction. In this aspect, the internal vibrating body includes a base that is connectable to the light transmission body in the first direction and connectable to the external vibrating body in the second direction; and a first portion that extends in a direction away from the light transmission body along the first direction from the base portion. At least one of the base and the first portion includes a convex portion that protrudes in the second direction from the base portion or the first portion.

According to the present disclosure, a vibrating device is provided that is configured to remove foreign substances adhered to a light transmission body while suppressing deformation of the light transmission body, and an internal vibrating body that makes it possible to realize the vibrating device.

### BRIEF DESCRIPTION OF DRAWINGS

FIG. 1 is a perspective view showing a vibrating device that includes an internal vibrating body of an exemplary aspect of the present disclosure.

FIG. 2 is a cross-sectional view along line II-II of FIG. 1.

FIG. 3 is a partial enlarged view of FIG. 2.

FIG. 4 is a cross-sectional view showing Modification 1 of the vibrating device of FIG. 1.

FIG. 5 is a cross-sectional view showing Modification 2 of the vibrating device of FIG. 1.

FIG. 6 is a cross-sectional view showing Modification 3 of the vibrating device of FIG. 1.

FIG. 7 shows results of simulation of a deformation amount distribution of the vibrating device of FIG. 6.

FIG. 8 is a cross-sectional view showing Modification 4 of the vibrating device of FIG. 1.

FIG. 9 shows results of simulation of a deformation amount distribution of a vibrating device not including a suppressing portion.

### DESCRIPTION OF EMBODIMENTS

Various exemplary aspects of the present disclosure are described.

Exemplary aspects of the present disclosure are described below based on the attached drawings. The descriptions below are essentially merely exemplifications and are not intended to limit applicable objects of the present disclosure or uses of the exemplary aspects of the present disclosure. The figures are schematic figures, and, for example, illustrated dimensional ratios of the figures do not necessarily correspond to actual dimensional ratios.

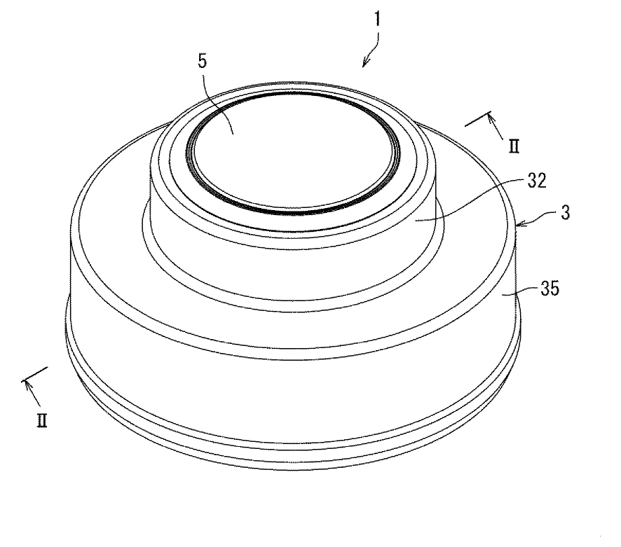

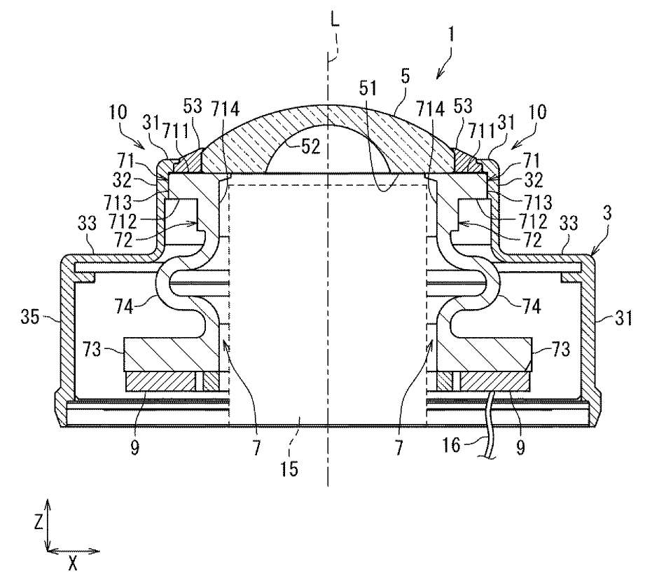

As shown in FIGS. 1 and 2, a vibrating device 1 includes an internal vibrating body 7, a piezoelectric element 9, a lens (an example of a light transmission body) 5, an external vibrating body 3, and a suppressing portion 10. The piezoelectric element 9 is connected to one end (e.g., a first end) of the internal vibrating body 7 in a first direction (for example, a Z direction). A wire 16 is connected to the piezoelectric element 9, and a voltage is applied to the piezoelectric element 9 through the wire 16. The lens 5 is connected to the other end (e.g., a second end) of the internal vibrating body 7 in the first direction Z. The lens 5 includes an optical axis L that extends along the first direction Z. In operation, vibration that is generated by the piezoelectric element 9 is transmitted to the lens 5 through the internal vibrating body 7, and the lens 5 vibrates. This causes foreign substances, such as raindrops or dirt, adhered to the lens 5 to be removed.

In the present aspect, as shown in FIG. 2, the vibrating device 1 includes a lens module 15 that is positioned in the internal vibrating body 7. The lens module 15, when viewed along the first direction Z, is positioned so as to overlap the optical axis L of the lens 5. The lens module 15, by being combined with the lens 5, is formed so as to achieve optical performance that facilitates image capturing as an image capturing element. For example, the lens module 15 includes a plurality of lenses, and is supported by a lens barrel.

The internal vibrating body 7 is formed so as to be configured to amplify the vibration generated by the piezoelectric element 9. The internal vibrating body 7 is made of, for example, a metal material or ceramic. Examples of the metal material of which the internal vibrating body 7 is made include stainless steel, aluminum, iron, titanium, and duralumin. In order to increase the adhesion of an adhesive, a surface of the internal vibrating body 7 may be subjected to surface treatment, such as oxidation treatment or alumite treatment. For example, by causing the surface of the internal vibrating body 7 to be black by the surface treatment, a reduction in the optical performance caused by diffuse reflection of light can be prevented.

In the present aspect, in one example, the internal vibrating body 7 has a cylindrical shape and is symmetrically positioned with respect to the optical axis L. For purposes of this disclosure, the term “cylindrical shape” includes, for example, a circular cylindrical shape and a rectangular tube shape. The internal vibrating body 7 includes a base portion 71 (e.g., a base) that contacts the lens 5, a first portion 72 that extends in a direction away from the lens 5 along the first direction Z from the base portion 71, a second portion 73 to which the piezoelectric element 9 is attached, and a third portion 74 that connects the first portion 72 to the second portion 73. The base portion 71, the first portion 72, and the second portion 73 each have a cylindrical shape that extends along the first direction Z. The base portion 71, the first portion 72, the second portion 73, and the third portion 74 may be integrated with each other or may be separately formed.

The base portion 71 has, for example, a substantially rectangular cross-sectional shape in which a second direction that intersects the first direction Z (for example, a radial direction with respect to the optical axis L including an X direction) is a longitudinal direction. The base portion 71 is formed such that its dimension in the second direction is larger than that of the first portion 72. Of two ends of the base portion 71 in the first direction Z, an end portion 711 that is farther from the piezoelectric element 9 is connected to the lens 5, and an end portion 712 that is nearer (closer to) the piezoelectric element 9 is connected to the first portion 72. Of two ends of the base portion 71 in the second direction, an end portion 713 that is farther from the optical axis L is connected to the external vibrating body 3, and an end portion 714 that is nearer (closer to) the optical axis L faces the inner-layer lens module 15 with a gap therebetween.

The first portion 72 and the second portion 73 are formed so as to vibrate as the piezoelectric element 9 vibrates. The third portion 74 has a substantially S shape in cross section. The third portion 74 is formed so as to support the first portion 72 and transmit the vibration of the second portion 73 to the first portion 72.

The internal vibrating body 7 can have the following structures. These configurations enable the vibration of the piezoelectric element 9 to be efficiently transmitted to the lens 5.

In an exemplary aspect, the plate thickness (that is, a dimension in the first direction Z) of the second portion 73 is larger than the width of the first portion 72 and the width of the third portion 74.

In another exemplary aspect, a maximum external dimension (that is, a maximum dimension in the second direction) of the third portion 74 is larger than a maximum external dimension of the first portion 72.

In an exemplary aspect, a maximum external dimension (that is, a maximum dimension in the second direction) of the second portion 73 is larger than a maximum external dimension of the third portion 74.

The external vibrating body 3 to prevent or inhibit the vibration of the internal vibrating body 7 from escaping to members other than the lens 5 and efficiently transmitting the vibration to the lens 5. In one example, the external vibrating body 3 is formed so as to be positioned on an outer side of the internal vibrating body 7 in a radial direction with respect to the optical axis L (hereunder referred to as the “radial direction”) and surround the internal vibrating body 7, that is, so as to cover the entire (or at least partial) internal vibrating body 7 and protecting the internal vibrating body 7 from the outside thereof. The external vibrating body 3 is made of, for example, a metal material, such as stainless steel, aluminum, iron, titanium, and duralumin, or resin.

The external vibrating body 3 includes a first connection portion 31, a cylinder portion 32, and a second connection portion 33. In the present aspect, the external vibrating body 3 has a cylindrical shape, and includes a fixing portion 35. The first connection portion 31, the cylinder portion 32, the second connection portion 33, and the fixing portion 35 may be integrated with each other or may be separately formed in various exemplary aspects.

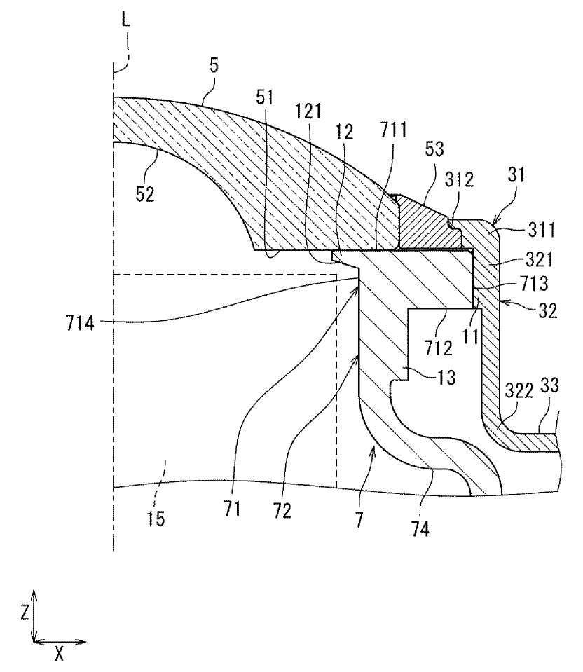

As shown in FIG. 2, the first connection portion 31 is connected to the lens 5. Although, in the present aspect, the first connection portion 31 is indirectly connected to the lens 5 with a resin guide member 53 that is provided at an end portion on an outer side of the lens 5 in a radial direction being interposed therebetween, the first connection portion 31 may be directly connected to the lens 5 without the guide member 53 being interposed therebetween. As shown in FIG. 3, the first connection portion 31 includes a body portion 311 and a protruding portion 312. The body portion 311 is connected to one end of the cylinder portion 32 in the first direction Z and extends up to a location nearer the optical axis L than the cylinder portion 32 along the second direction. The protruding portion 312 protrudes in a direction approaching the lens 5 from, of two end portions of the body portion 311 in the second direction, the end portion nearer the optical axis L. A part of the body portion 311 faces the base portion 71 of the internal vibrating body 7 in the first direction Z. Moreover, the guide member 53 is interposed between the protruding portion 312 and the base portion 71 in the first direction Z. Therefore, the connection between the lens 5 and the internal vibrating body 7 is maintained.

As shown in FIG. 3, the cylinder portion 32 extends along the first direction Z and includes a first end portion (e.g., also considered a first end) 321 that is connected to the first connection portion 31 and a second end portion 322 (e.g., also considered a second end) that is connected to the second connection portion 33. In one example, as shown in FIG. 1, the cylinder portion 32 has a cylindrical shape and is formed around the optical axis L so as to surround the internal vibrating body 7. The cylinder portion 32 has an inside diameter that is larger than the inside diameter of the first connection portion 31 and includes a step at an inner surface of the external vibrating body 3. A gap is formed between the cylinder portion 32 and the internal vibrating body 7 excluding the base portion 71. Since the cylinder portion 32 has a thickness that is smaller than the thickness of the fixing portion 35 and has a small wall thickness, the cylinder portion 32 has spring characteristics.

As shown in FIG. 2, the second connection portion 33 is formed so as to extend in a direction away from the lens 5 along the second direction from the second end portion 322 of the cylinder portion 32 and attenuate the vibration generated by the piezoelectric element 9. Since the second connection portion 33 has a thickness that is smaller than the thickness of the fixing portion 35 and has a small wall thickness, the second connection portion 33 has spring characteristics.

As shown in FIG. 2, the fixing portion 35 extends in a direction away from the lens 5 along the first direction Z from, of two end portions of the second connection portion 33 in the second direction, the end portion that is farther away from the cylinder portion 32. In one example, as shown in FIG. 1, the fixing portion 35 has a cylindrical shape. In the present aspect, the fixing portion 35 includes a node in which vibration is suppressed to a vibration less than or equal to 1/100 of the deformation amount of the lens 5 and is formed to suppress or inhibit vibration that propagates to members (for example, a case that accommodates an image capturing element, and the lens module) that are connected to the fixing portion 35.

The lens 5 forms an optical image-formation surface together with the lens module 15 and is disposed at an outermost layer of an optical system Ps including the lens 5 and the lens module 15. The lens 5 is made of glass, an upper surface of the lens 5 has a convex shape, and a surface thereof is coated with a water-repellant coat and an anti-reflection film (AR coat). In an exemplary aspect, a surface of the lens 5 on a side of the optical image-formation surface includes a planar portion 51 and a concave portion 52, the concave portion 52 is positioned at substantially the center of the lens 5, and the planar portion 51 is positioned around the concave portion 52.

The piezoelectric element 9 includes a piezoelectric body and an electrode and is configured generate vibration upon excitation. The piezoelectric body is made of, for example, appropriate piezoelectric ceramic materials, such as barium titanate (BaTiO3), lead zirconate titanate PZT: PbTiO3·PbZrO3), lead titanate (PbTiO3), lead metaniobate (PbNb2O6), bismuth titanate (Bi4Ti3O12), and (K, Na)NbO3, or appropriate piezoelectric monocrystals, such as LiTaO3 and LiNbO3. The electrode is made of, for example, Ni, Ag, or Au.

As shown in FIG. 2, the piezoelectric element 9 is positioned symmetrically to the optical axis L. The piezoelectric element 9 in plain view when viewed along the first direction Z has, for example, a ring shape.

The guide member 53 and the first connection portion 31, the lens 5 and the base portion 71, the piezoelectric element 9 and the second portion 73, and the base portion 71 and a first convex portion 11 (described later) are connected to each other with, for example, an adhesive. The adhesive includes, for example, epoxy resin. Moreover, transmission loss of vibration can be reduced between two members by using an adhesive having a high Young’s modulus.

The suppressing portion 10 is formed so as to suppress a difference between the deformation amount of the first end portion 321 and the deformation amount of the second end portion 322, in which the difference being caused by the vibration generated by the piezoelectric element 9, and is positioned between the lens 5 and the second connection portion 33 in the first direction Z. In other words, the suppressing portion 10 is configured to be able to adjust the rigidities of the external vibrating body 3 and the internal vibrating body 7 and suppressing strain caused by a difference between the thermal deformation amounts of the second connection portion 33 and the first connection portion 31 of the external vibrating body 3.

In the present aspect, as shown in FIG. 3, the suppressing portion 10 includes the first convex portion 11, a second convex portion 12, and a third convex portion 13.

The first convex portion 11 is provided at the cylinder portion 32. For example, the first convex portion 11 is integrated with the cylinder portion 32 in a range that does not extend beyond the center of the cylinder portion 32 in the first direction Z from the first end portion 321 of the cylinder portion 32. The first convex portion 11 protrudes toward the optical axis L along the second direction from a portion on an inner side of the cylinder portion 32 in a radial direction. The first convex portion 11 has a dimension in the first direction Z that is substantially the same as that of the base portion 71. An end of the first convex portion 11 is connected to the end portion 713 of the base portion 71. An end of the first convex portion 11 on a side of the first end portion 321 in the first direction Z is connected to the first connection portion 31. The first convex portion 11 is formed such that its dimension in the second direction is smaller than that of the cylinder portion 32.

The second convex portion 12 is provided at the base portion 71. For example, the second convex portion 12 is integrated with the base portion 71 in a range that does not extend beyond the center of the base portion 71 in the first direction Z from the end portion 711 of the base portion 71. One end of the second convex portion 12 in the first direction Z is, for example, connected to the lens 5 with an adhesive. An end portion 121 of the second convex portion 12 situated away from the lens 5 in the first direction is inclined so as to be situated nearer the lens 5 in the first direction Z with decreasing distance to the optical axis L in the second direction. The second convex portion 12 is formed such that its dimension in the second direction is smaller than that of the base portion 71.

The third convex portion 13 is provided at the first portion 72. For example, the third convex portion 13 is integrated with the first portion 72 in a range up to substantially the third portion 74 from an end portion of the first portion 72 that is connected to the base portion 71 in the first direction. The third convex portion 13 protrudes in a direction away from the optical axis L along the second direction from the end portion 714 of the first portion 72. One end of the third convex portion 13 in the first direction Z is connected to the end portion 712 of the base portion 71. The third convex portion 13 is formed such that its dimension in the second direction is smaller than that of the first portion 72.

The vibrating device 1 can provide the following effects.

The vibrating device 1 includes the internal vibrating body 7, the piezoelectric element 9, the lens 5, the external vibrating body 3, and the suppressing portion 10. The internal vibrating body 7 is configured to amplify vibration. The piezoelectric element 9 is connected to one end of the internal vibrating body 7 in the first direction and is configured to generate vibration. The lens 5 is connected to the other end of the internal vibrating body 7 in the first direction and includes the optical axis L extending along the first direction. The external vibrating body 3 is formed so as to be positioned on an outer side of the internal vibrating body 7 in the second direction intersecting the first direction and to surround the internal vibrating body 7. The external vibrating body 3 includes the first connection portion 31, the second connection portion 33, and the cylinder portion 32. The first connection portion 31 is connected to the lens 5. The second connection portion 33 is formed so as to extend in a direction away from the lens 5 along the second direction and attenuate vibration. The cylinder portion 32 extends along the first direction and includes the first end portion 321 that is connected to the first connection portion 31 and the second end portion 322 that is connected to the second connection portion 33. The suppressing portion 10 is configured to suppress a difference between the deformation amount of the first end portion 321 and the deformation amount of the second end portion 322, in which the difference being caused by the vibration generated by the piezoelectric element 9, and is positioned between the lens 5 and the second connection portion 33 in the first direction Z. Such a structure and configuration suppress thermal stress and vibration stress that are applied to the lens 5. As a result, the vibrating device 1 can be provided that is configured to remove foreign substances adhered to the lens 5 while suppressing deformation of the lens 5.

The external vibrating body 3 is often made of an aluminum alloy having a large coefficient of linear expansion and tends to be thermally deformed. Since the deformation amount of the second connection portion 33 in a radial direction is large, the deformation amount in a radial direction of the second end portion 322 of the cylinder portion 32 relatively increases. Due to the difference between the deformation amounts, a force acting in a direction in which the lens 5 warps are applied to the lens 5 and the lens 5 may be cracked. In the vibrating device 1, the suppressing portion 10 suppresses the difference in the deformation amount between the first end portion 321 and the second end portion 322 of the cylinder portion 32. In other words, the suppressing portion 10 adjusts the rigidities of the external vibrating body 3 and the internal vibrating body 7 and adjusts the imbalance between the deformation amount of the cylinder portion 32 on a side of the lens 5 and the deformation amount of the cylinder portion 32 on a side of the second connection portion 33.

The internal vibrating body 7 includes the base portion 71 and the first portion 72. The base portion 71 is connected to the lens 5 in the first direction and is connected to the first end portion 321 in the second direction. The first portion 72 extends in a direction away from the lens 5 in the first direction from the base portion 71. The suppressing portion 10 is positioned at the cylinder portion 32, the base portion 71, and the first portion 72. Such a structure makes it possible to more reliably suppress thermal stress and vibration stress that are applied to the lens 5. As a result, the vibrating device 1 is provided that is configured to remove foreign substances adhered to the lens 5 while suppressing deformation of the lens 5.

The suppressing portion 10 includes the first convex portion 11, the second convex portion 12, and the third convex portion 13. The first convex portion 11 protrudes in a radial direction from the cylinder portion 32. The second convex portion 12 protrudes in a radial direction from the base portion 71. The third convex portion 13 protrudes in a radial direction from the first portion 72. Such a structure makes it possible to more reliably suppress thermal stress and vibration stress that are applied to the lens 5. As a result, the vibrating device 1 is provided that is configured to remove foreign substances adhered to the lens 5 while suppressing deformation of the lens 5.

When, due to the first convex portion 11, for example, the first end portion 321 of the cylinder portion 32 is made thick, the deformation amount on a side of the first end portion 321 is increased and thus the imbalance with respect to the deformation amount on a side of the second end portion 322 is eliminated. When, due to the second convex portion 12, for example, an end portion of the base portion 71 on a side of the lens 5 is made thick, the joining area of the internal vibrating body 7 with respect to the lens 5 is increased, and thus the rigidity of the base portion 71 with respect to a force acting in a direction in which the lens 5 warps is increased. When, due to the third convex portion 13, the first portion 72 is made thick, the first portion 72 is given the role of an angle brace that supports the force acting in the direction in which the lens 5 warps and thus the rigidity of the first portion 72 with respect to the force acting in the direction in which the lens 5 warps is increased. That is, the second convex portion 12 and the third convex portion 13 form at least a part of a rigid portion that increases the rigidity of the internal vibrating body 7.

In an exemplary aspect, the vibrating device 1 includes the resin guide member 53 that is provided at an end portion of the lens 5 in the second direction. The first connection portion 31 is connected to the lens 5 with the guide member 53 being interposed therebetween. Such a structure and configuration suppress stress that is applied to the lens 5 compared to when the connection of the lens 5 and the internal vibrating body 7 is maintained by using a metal member.

The internal vibrating body 7 of the vibrating device 1 includes the base portion 71, the first portion 72, and the suppressing portion 10. The base portion 71 is formed so as to be connectable to the lens 5 in the first direction and connectable to the first end portion 321 in the second direction. The first portion 72 extends in a direction away from the lens 5 along the first direction from the base portion 71. The suppressing portion 10 is provided at at least one of the base portions 71 and the first portion 72 and is formed so as to suppress a difference between the deformation amount of the first end portion 321 and the deformation amount of the second end portion 322, the difference being caused by the vibration generated by the piezoelectric element 9. In other words, the internal vibrating body 7 to whose one end

is connected in the first direction to the piezoelectric element 9 the generates vibration upon excitation, and to whose other end is connected in the first direction to the lens 5 including the optical axis L extending along the first direction, and that can be surrounded by the external vibrating body 3 that is positioned on an outer side in the second direction intersecting the first direction includes the base portion 71 and the first portion 72; and at least one of the base portion 71 and the first portion 72 includes a convex portion (for example, the second convex portion 12 and/or the third convex portion 13) that protrudes in the second direction from the base portion 71 or the first portion 72. The internal vibrating body 7 to whose one end is connected in the first direction to the piezoelectric element 9 that generates vibration upon excitation, to whose other end is connected in the first direction to the lens 5 including the optical axis L extending along the first direction, and that can be surrounded by the external vibrating body 3 that is positioned on an outer side in the second direction intersecting the first direction includes the base portion 71, the first portion 72, and the rigid portion. The base portion 71 is formed so as to be connectable to the lens 5 in the first direction and connectable to the external vibrating body 3 in the second direction. The first portion 72 extends in a direction away from the lens 5 along the first direction from the base portion 71. The rigid portion is provided at at least one of the base portions 71 and the first portion 72 and is formed so as to make the rigidity of the base portion 71 or the rigidity of the first portion 72 higher than the rigidity of the external vibrating body 3. When the internal vibrating body 7 is applied to the vibrating device 1, such a structure and configuration suppress thermal stress and vibration stress that are applied to the lens 5 of the vibrating device 1. As a result, the internal vibrating body 7 is provided that provides the vibrating device 1 configured to remove foreign substances adhered to the lens 5 while suppressing deformation of the lens 5. The rigid portion is not limited to one including the second convex portion 12 and the third convex portion 13; the internal vibrating body 7 may be made of a material having a Young’s modulus that is higher than that of the external vibrating body 3 and a part of or the entire internal vibrating body 7 may be the rigid portion.

The vibrating device 1 can having the following structures.

The suppressing portion 10 is to be positioned at at least one of the cylinder portion 32, the base portion 71, and the first portion 72. For example, the suppressing portion 10 is to include at least one of the first convex portion 11, the second convex portion 12, and the third convex portion 13. For example, with regard to a dimension in a radial direction (in other words, the wall thickness), when the dependency in the direction of the optical axis L is determined by a first approximation, each convex portion is to be formed such that, at at least one location, the wall thickness on an image capturing side (in other words, a side near the lens 5 with respect to the center in the first direction Z) is larger than the wall thickness on an image capturing element side (in other words, a side situated away from the lens 5 with respect to the center in the first direction Z).

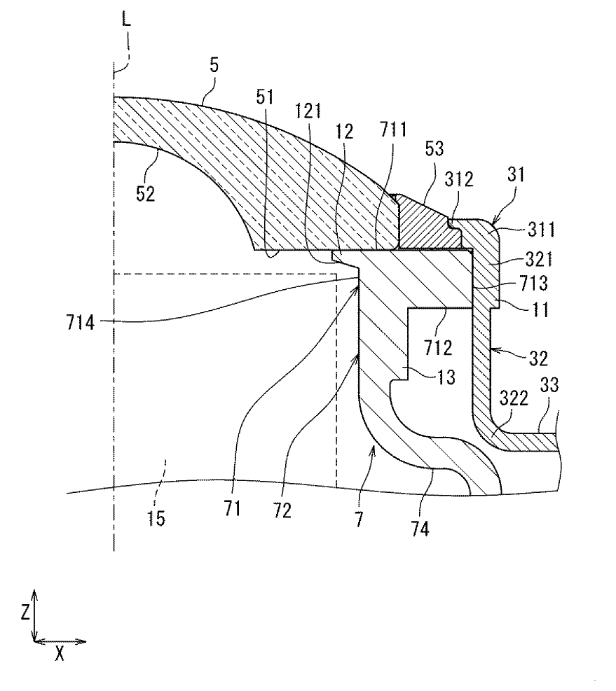

As shown in FIG. 4, the first convex portion 11 may be formed so as to protrude in a direction away from the optical axis L along a radial direction from an outer portion of the cylinder portion 32 in the radial direction. Such a structure and configuration can increase a dimension of the second connection portion 33 in the radial direction.

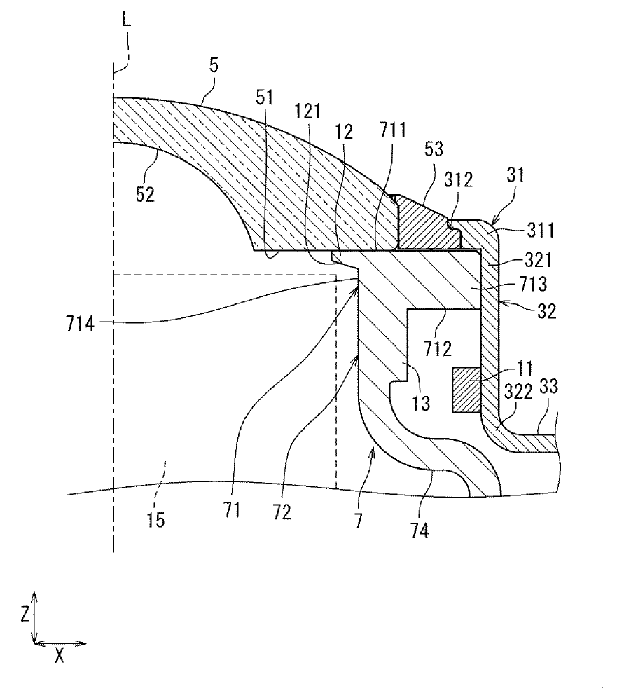

As shown in FIG. 5, the first convex portion 11 may be formed so as to be positioned nearer the second end portion 322 than the first end portion 321. In the vibrating device 1 of FIG. 5, the first convex portion 11 is positioned between the cylinder portion 32 and the second portion 73 of the internal vibrating body 7 in a radial direction and is formed from a member different from the external vibrating body 3. The first convex portion 11 is formed such that its dimension in the second direction is larger than that of the cylinder portion 32 and its coefficient of linear expansion is smaller than that of the external vibrating body 3. For example, the external vibrating body 3 (for example, the cylinder portion 32 and the second connection portion 33) is made of an aluminum alloy, and the first convex portion 11 is made of stainless steel (SUS). Such a structure and configuration suppress or inhibits the deformation amount in a radial direction of a portion of the cylinder portion 32 where the first convex portion 11 is formed. In one example, the first convex portion 11 of FIG. 5 is formed such that its dimension in the second direction is larger than that of the cylinder portion 32.

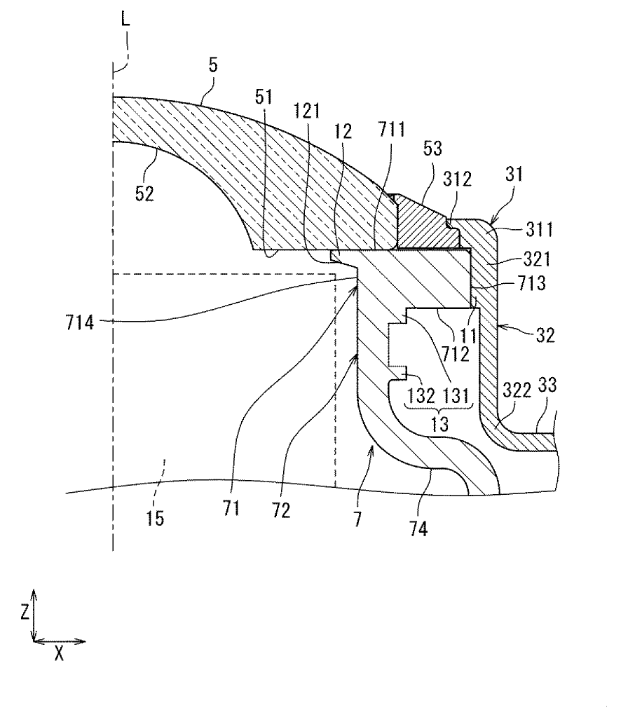

As shown in FIG. 6, the third convex portion 13 may be formed so as to include two projecting portions 131 and 132. In the vibrating device 1 of FIG. 6, the projecting portion 131 is provided in a range that does not extend beyond the center of the first portion 72 in the first direction Z from an end portion of the first portion 72 that is connected to the base portion 71 in the first direction Z. The projecting portion 132 is provided nearer the third portion 74 than the center of the first portion 72 in the first direction Z.

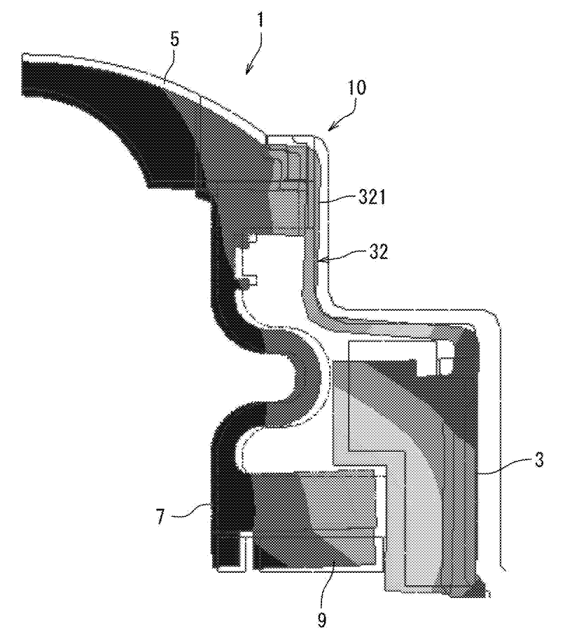

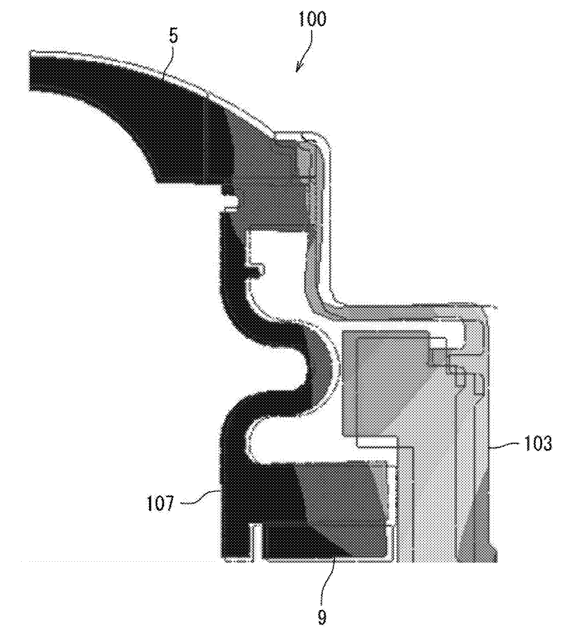

FIG. 7 shows results of simulation of a deformation amount distribution of the vibrating device 1 of FIG. 6. FIG. 9 shows results of simulation of a deformation amount distribution of a vibrating device 100 not including a suppressing portion 10. In the vibrating device 100 of FIG. 9, an external vibrating body 103 does not include a first convex portion 11, and an internal vibrating body 107 does not include a second convex portion 12 and a third convex portion 13. When FIGS. 7 and 9 are compared, the difference in deformation amount between the first end portion 321 and the second end portion 322 of the cylinder portion 32 is smaller for the vibrating device 1 than for the vibrating device 100. That is, the suppressing portion 10 is configured to suppress the difference between the deformation amount of the first end portion 321 and the deformation amount of the second end portion 322, in which the difference being caused by the vibration generated by the piezoelectric element 9.

When the third convex portion 13 is to be omitted, effects that are the same as those provided by the third convex portion 13 can be obtained by rounding or chamfering a bent portion of the first portion 72. That is, the first portion 72 can be given the role of an angle brace that supports a force acting in a direction in which the lens 5 warps.

In an exemplary aspect, the vibrating device 1 may be formed such that the coefficient of linear expansion of the internal vibrating body 7 is smaller than the coefficient of linear expansion of the external vibrating body 3 and such that the Young’s modulus of the internal vibrating body 7 is higher than the Young’s modulus of the external vibrating body 3. Such a structure and configuration provides the vibrating device 1 that is configured to suppress deformation of the lens 5 and has vibration characteristics that remove foreign substances adhered to the lens 5.

The suppressing portion 10 may be formed from a member different from the internal vibrating body 7 or the external vibrating body 3. Such a structure makes it possible to reduce production costs of the vibrating device 1.

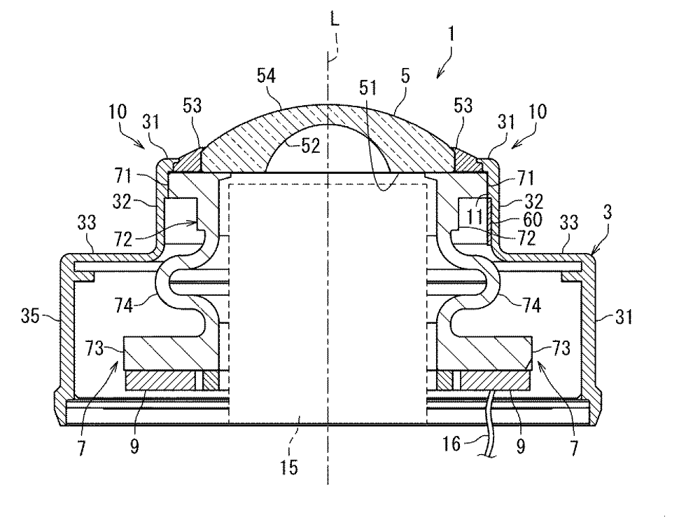

In an exemplary aspect, the cylinder portion 32 may include a weight member 60 that causes the cylinder portion 32 or the first portion 72 to be axially asymmetrical with respect to the optical axis L. In the vibrating device 1 of FIG. 8, the weight member 60 is provided in a range up to the second connection portion 33 along the first direction Z from the first convex portion 11 at a portion

of the cylinder portion 32 on an inner side in a radial direction. In one example, the weight member 60, when viewed along the first direction Z, has a substantially semicircular arc shape and a radial dimension that is substantially the same. The weight member 60 may be made of a material that is of the same type as the material of the external vibrating body 3 or may be made of a material that is of a different type from the material of the external vibrating body 3. Such a structure and configuration provide a slope to the amplitude of the lens 5 without impairing the axial symmetry of the internal vibrating body 7. It is noted that the phrase “to provide a slope to the amplitude of the lens 5” can refer to forming at a surface 54 of the lens 5 a region where the lens 5 vibrates with a large amplitude and a region where the lens 5 vibrates with a small amplitude. In the vibrating device 1 of FIG. 8, from a side of the cylinder portion 32 where the weight member 60 is provided, a wire 16 is connected to the piezoelectric element 9. This configuration can suppress breakage of the wire 16 and sound produced by vibration of the wire 16.

When, of the various aspects or modifications, any of the aspects or modifications are combined as appropriate, the effects of the combined aspects or modifications can be provided. It is possible to combine any of the aspects, any of the examples, or any of the aspects and any of the examples, and it is possible to combine features of different ones of the aspects or features of different ones of the examples.

### REFERENCE SIGNS LIST

1 vibrating device

3 external vibrating body

5 lens

7 internal vibrating body

71 base portion

711, 712, 713, 714 end portion

72 first portion

73 second portion

74 third portion

9 piezoelectric element

10 suppressing portion

11 first convex portion

12 second convex portion

121 end portion

13 third convex portion

131, 132 projecting portion

15 lens module

16 wire

31 first connection portion

311 body portion

312 protruding portion

32 cylinder portion

321 first end portion

322 second end portion

33 second connection portion

35 fixing portion

51 planar portion

52 concave portion

53 guide member

54 surface

60 weight member

1. A vibrating device comprising:
an internal vibrating body configured to amplify vibration;
a piezoelectric element that is connected to a first end of the internal vibrating body in a first direction and that is configured to generate the vibration;
a light transmission body that is connected to a second end of the internal vibrating body in the first direction and that includes an optical axis extending along the first direction;
an external vibrating body that is positioned on an outer side of the internal vibrating body in a second direction that intersects the first direction and that at least partially surrounds the internal vibrating body,
wherein the external vibrating body includes:
a first connection portion that is connected to the light transmission body,
a second connection portion that extends in a direction away from the light transmission body along the second direction, and
a cylinder portion that extends along the first direction and that includes a first end and a second end, the first end connected to the first connection portion, and the second end connected to the second connection portion; and
a suppressing portion configued to suppress a difference between a deformation amount of the first end of the cylinder portion and a deformation amount of the second end of the cylinder portion,
wherein the difference is caused by the vibration generated by the piezoelectric element, and
wherein the suppressing portion is positioned between the light transmission body and the second connection portion in the first direction.

2. The vibrating device according to claim 1, wherein the external vibrating body completely surrounds the internal vibrating body.

3. The vibrating device according to claim 1, wherein the internal vibrating body includes:
a base that is connected to the light transmission body in the first direction and that is connected to the first end of the cylindrical portion in the second direction, and
a first portion that extends in a direction away from the light transmission body along the first direction from the base.

4. The vibrating device according to claim 3, wherein the suppressing portion is positioned at at least one of the cylinder portion, the base, and the first portion of the internal vibrating body.

5. The vibrating device according to claim 4, wherein the suppressing portion includes at least one of a first convex portion that protrudes in the second direction from the cylinder portion, a second convex portion that protrudes in the second direction from the base of the internal vibrating body, and a third convex portion that protrudes in the second direction from the first portion of the internal vibrating body.

6. The vibrating device according to claim 5, wherein the first convex portion is positioned nearer the second end of the cylindrical portion than the first end of the cylindrical portion and has a coefficient of linear expansion that is smaller than a coefficient of linear expansion of the external vibrating body.

7. The vibrating device according to claim 1, wherein the internal vibrating body has a coefficient of linear expansion that is smaller than a coefficient of linear expansion of the external vibrating body, and the internal vibrating body has a Young’s modulus that is higher than a Young’s modulus of the external vibrating body.

8. The vibrating device according to claim 1, further comprising a guide member comprising resin and that is provided at an end of the light transmission body in the second direction.

9. The vibrating device according to claim 8, wherein the first connection portion is connected to the light transmission body with the guide member interposed therebetween.

10. The vibrating device according to claim 3, wherein the suppressing portion comprises a member that is different from each of the internal vibrating body and the external vibrating body.

11. The vibrating device according to claim 3, wherein the cylinder portion includes a weight member configured to cause the cylinder portion or the first portion of the internal vibrating body to be axially asymmetrical with respect to the optical axis.

12. The vibrating device according to claim 3, wherein the internal vibrating body further includes a second portion attached to the piezoelectric element, and a third portion that connects the first portion to the second portion.

13. The vibrating device according to claim 12, wherein the first portion and the second portion are configured to vibrate as the piezoelectric element generates the vibration.

14. The vibrating device according to claim 13, wherein the third portion has a substantially S-shaped cross section and is configured to transmit the vibration of the second portion to the first portion.

15. The vibrating device according to claim 13, wherein a thickness of the second portion in the first direction is larger than a width in the second direction of the first portion and a width in the second direction of the third portion.

16. The vibrating device according to claim 13, wherein a maximum external dimension in the second direction of the third portion is larger than a maximum external dimension in the second direction of the first portion.

17. The vibrating device according to claim 13, wherein a maximum external dimension in the second direction of the second portion is larger than a maximum external dimension in the second direction of the third portion.

18. The vibrating device according to claim 1, wherein the cylinder portion has an inside diameter that is larger than an inside diameter of the first connection portion and includes a step at an inner surface of the external vibrating body.

19. An internal vibrating body with a first end connected in a first direction to a piezoelectric element configured to generate vibration, a second end connected in the first direction to a light transmission body including an optical axis extending along the first direction, and an external vibrating body is positioned on an outer side of the internal vibrating body in a second direction intersecting the first direction, the internal vibrating body comprising:
a base connectable to the light transmission body in the first direction and connectable to the external vibrating body in the second direction; and
a first portion that extends in a direction away from the light transmission body along the first direction from the base,
wherein at least one of the base and the first portion includes a convex portion that protrudes in the second direction from the base or the first portion, respectively.

20. An internal vibrating body having a first end connected in a first direction to a piezoelectric element configured to generate vibration, and a second end connected in the first direction to a light transmission body that includes an optical axis extending along the first direction, and that is surrounded by an external vibrating body that is positioned on an outer side in a second direction intersecting the first direction, the internal vibrating body comprising:
a base connectable to the light transmission body in the first direction and connectable to the external vibrating body in the second direction;
a first portion that extends in a direction away from the light transmission body along the first direction from the base; and
a rigid portion that is provided at at least one of the base and the first portion,
wherein a rigidity of the base or the first portion is higher than a rigidity of the external vibrating body.
